(19) United States
(12) Patent Application Publication
(10) Pub. No.: US 2005/0111042 A1
(43) Pub. Date: May 26, 2005

(54) Printing system, image sensing apparatus, printing method, computer program, and computer-readable storage medium

(75) Inventor: Satoshi Ogiwara, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/968,057

(22) Filed: Oct. 20, 2004

(30) Foreign Application Priority Data
Oct. 22, 2003 (JP) 2003-362501

(51) Int. Cl. G06F 15/00

(52) U.S. Cl. 358/1.18; 358/1.15

(57) ABSTRACT

When a digital camera DC, having a sensor for detecting an orientation of the digital camera DC, transmits an image signal to a printer for printing an image, a layout of character data, e.g., a date, to be printed with the image can be determined in accordance with the orientation of the camera at the time of print designation of image in the digital camera DC, and the character data can be printed with the image on a printing medium in the layout in accordance with the orientation of the camera.

### FIELD OF THE INVENTION

The present invention relates to a printing system, an image sensing apparatus, a printing method, a computer program, and a computer-readable storage medium which are suitably used in a case of printing an image based on an electronic image signal, obtained by an image sensing apparatus such as a digital camera, on a printing medium such as a recording paper.

### BACKGROUND OF THE INVENTION

A thermal-transfer printer, an inkjet printer and so on are available as a printer employed in a printing system. Taking inkjet printers as an example, by virtue of advancement in the liquid droplet refining technology, inkjet printers achieving a higher resolution and higher quality are emerging. Furthermore, in the printers adopting a thermal-transfer method, a line type of thermal-transfer printer has conventionally been known. The line type of thermal-transfer printer realizes printing on a thermal recording paper by selectively driving plural numbers of heating elements arranged in a main-scanning direction, printing an image in line unit, and conveying the paper in the sub-scanning direction in accordance with the image printing.

As printing means, the thermal-transfer printers recently attract attentions along with the development of an image input device, e.g., a digital camera, a digital video camera, a scanner and so forth. The main reason of the attention is described hereinafter. First, since an inkjet printer merely has binary options of discharging or not discharging a liquid droplet, it achieves an apparent resolution and tonality by utilizing a technique such as error diffusion on a small liquid droplet landed on paper. In comparison, a thermal-transfer printer can easily change the controllable value of heat for one pixel so that it can achieve a larger number of tones with respect to one pixel. Therefore, in comparison with the inkjet printer, the thermal-transfer printer can obtain a smooth and high-quality image. Furthermore, by virtue of the improved performance of a thermal head and a paper material, the thermal-transfer printer can achieve an image as good as a silver chloride picture in terms of finish quality. Therefore, keeping pace with the recent development of digital cameras and the like, the thermal-transfer printer is attracting attention particularly as a printer for printing photographic images.

In a printing system integrally comprising or directly connecting the above-described printer and an image input device, e.g., a digital camera, a digital video camera or the like, image data inputted by the image input device can be printed by a printer without an intermediation of a device, such as a computer, for processing the image data. By virtue of this system, image data obtained by a digital camera or a digital video camera can easily be printed out as a photograph, and it is very convenient.

For a specific example of the printing system, for instance, an image input/output system disclosed in Japanese Patent Application Laid-Open No. 10-243327 is given. The image input/output system is configured by connecting an image output apparatus with an image input apparatus. The image output apparatus, which receives an image signal from the image input apparatus, comprises a power source unit for supplying power to the image input apparatus. The image input apparatus is connected with the image output apparatus by a connection cable provided for transmitting image data to the image output apparatus and receiving power supply from the image output apparatus. The image input apparatus comprises a power source unit and determination means for determining whether or not it is possible to receive power supply from the image output apparatus. If the determination means determines that the image input apparatus can receive power supply from the image output apparatus, then the image input apparatus uses power from the image output apparatus; whereas if the determination means determines that the image input apparatus cannot receive power supply from the image output apparatus, then the image input apparatus uses power from its own power source unit. According to this image input/output system, since power can be supplied from the image output apparatus, printing can be performed without worrying about the remaining amount of the battery of the image input apparatus, such as a digital camera, thus it is very effective.

Furthermore, Japanese Patent Application Laid-Open No. 9-65182 discloses a multi-function camera. The multi-function camera is characterized particularly by power saving feature at the time of printing. The multi-function camera has an electronic viewfinder, and integrally comprises image sensing means for recording image data in a storage medium and printing means for printing out image data on recording paper. The camera further comprises control means for terminating power supply to the electronic viewfinder when the printing means is printing out image data on a recording paper. According to the multi-function camera, since-power is not supplied to the electronic viewfinder during, printing, power can be saved and it is very effective.

However, even if a printing system is constructed with the conventional image input/output system disclosed in Japanese Patent Application Laid-Open No. 10-243327 or the conventional multi-function camera disclosed in Japanese Patent Application Laid-Open No. 9-65182, the system is unable to provide sufficient satisfaction to users on the following points.

In a case where a user tries to print out character data, e.g., a date, along with image data, the output position and orientation of the character data is fixed regardless of an image. Therefore, when the orientation of the image is different from the orientation of the character data, the printout results in an unnatural poor-looking image.

In this respect, Japanese Patent Application Laid-Open No. 2002-165085 discloses a technique of determining a portrait image or a landscape image and changing the orientation of the date stamp in accordance with the determination. However, in this case, the orientation of the date stamp may not always be what the user wants.

### SUMMARY OF THE INVENTION

The present invention has been proposed in view of the above-described problems, and has characteristics of providing an image sensing apparatus, a printing system, and a control method of the printing system which can easily match the orientation of an image with the orientation of character data, such as a date, and print it as desired by a user.

According to one aspect of the present invention, it is possible to provide an image sensing apparatus, a printing system, and a control method of the printing system which can change the layout of character data printed with an image in accordance with the orientation of the image sensing apparatus at the time of selecting a target image to be printed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view showing an entire construction of a printing system according to an embodiment of the present invention;

FIG. 2 is a block diagram showing an example of a configuration of a digital camera DC according to the embodiment;

FIG. 3 depicts a view showing an example of a construction of a printer according to the embodiment;

FIG. 4 depicts an explanatory view of recording paper P;

FIG. 5 is a flowchart describing a printing process performed by the printer according to the embodiment;

FIG. 6 depicts an explanatory view of a memory map of a work memory in a digital camera DC according to the embodiment;

FIGS. 7A to 7C depict views showing a relation between the orientation of the digital camera DC according to the embodiment and recording paper on which image data and character data are printed (in a case of a frameless image);

FIGS. 8A to 8C depict views showing a relation between the orientation of the digital camera DC according to the embodiment and recording paper on which image data and character data are printed (in a case of a framed image);

FIG. 9 is a flowchart describing processing performed in the digital camera DC according to the present embodiment;

FIG. 10 depicts an explanatory view of printing-target-image selection in the digital camera DC according to the present embodiment; and

FIGS. 11A to 11C depict explanatory views showing an example of a date stamp and the orientation of the camera according to the present embodiment.

### DETAILED DESCRIPTION OF THE PREFERRED EMBODIMENT

A preferred embodiment of the present invention will now be described in detail in accordance with the accompanying drawings.

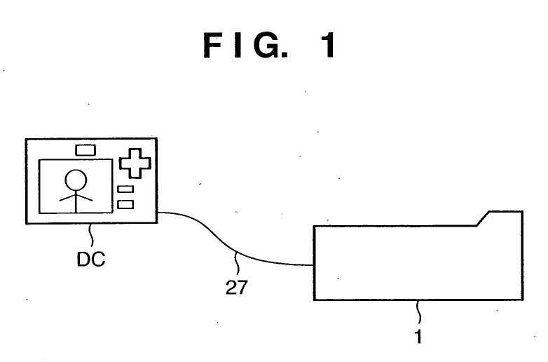

FIG. 1 depicts a view showing an entire construction of a printing system according to the embodiment. Herein, the printing system is constructed with a digital camera DC and a printer 1 connected through a cable 27. Note, besides this example where the apparatuses are connected through the cable 27 as shown in the drawing, they may be connected through, e.g., wireless communication.

In the digital camera DC, image data obtained by image sensing is stored in an internal memory. For a memory, a removable memory, e.g., a Compact Flash™ card, Smart Media™ and so forth is convenient. By operating an operation panel of the digital camera DC and setting a playback mode, a user can play back an arbitrary image from images stored in the internal memory. The played back image can be confirmed by displaying the image on a liquid crystal display unit of the digital camera DC as needed.

When the digital camera DC and the printer 1 are connected as shown in FIG. 1 keeping the communicatable state, necessary data is transmitted from the digital camera DC to the printer 1 upon depression of a predetermined print execution button (UI of the camera DC) (not shown), and desired printout can be obtained from the printer 1. The aforementioned necessary data includes negotiation data with the printer 1, image data to be printed, information added to the image data during or after the image recording, and so on.

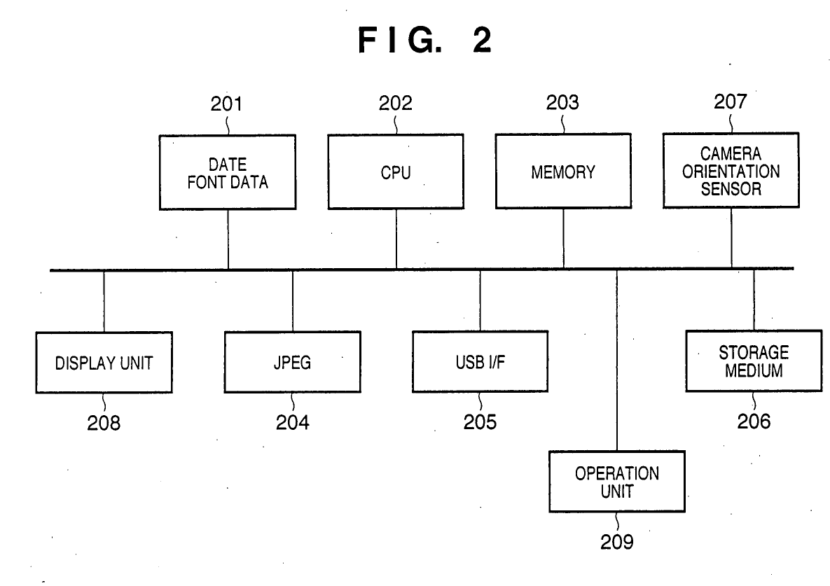

FIG. 2 is a block diagram showing an example of a configuration of the digital camera DC, serving as an image sensing apparatus according to the embodiment.

A date stamp font data storage unit 201 stores font data (character patterns) for printing a date. A CPU (Central Processing Unit) 202 controls operation of the entire camera DC in accordance with a control program stored in the program area of the memory 203. The memory 203 has a program area (ROM) mentioned above and a RAM area used as a work memory. A JPEG coder/decoder (CODEC) 204 is a hardware for performing JPEG coding on image data and performing JPEG decoding on the coded image data. A USB interface 205 is connected to the aforementioned printer 1 or a computer device, such as a personal computer, through a USB. A storage medium 206 is a medium for recording an image, e.g., a Compact Flash™ or the like. A sensor 207 is a sensor for detecting the orientation of the camera DC. Note that the digital camera DC is connected to the printer 1 through the USB interface 205 in this embodiment. A display unit 208 is, for instance, a liquid crystal display unit for displaying an image subjected to image sensing or displaying an image stored in the storage medium 206. In the display unit 208, a user interface (UI) for setting various image sensing conditions and inputting user setting is displayed. An operation unit 209 includes various key switches and buttons including a shutter switch, a mode switch, cursor keys for data setting on the UI screen, an enter key and so on. In this embodiment, the JPEG coding and decoding are performed using a hardware such as the coder/decoder (CODEC) 204 is a hardware for performing JPEG, but those may be achieved using a software implemented by the CPU 202.

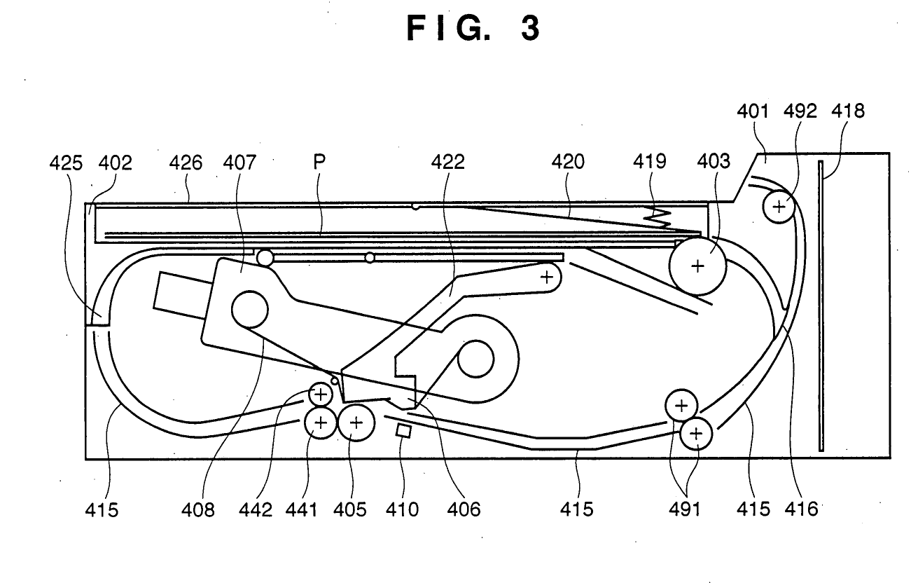

FIG. 3 shows an example of a construction of the printer 1 according to the embodiment. In the printing system according to the present embodiment, the printer 1 adopts a dye sublimation thermal-transfer printing method, and is constructed such that electronic image data can be printed for an arbitrary number of sheets.

The entire construction and operation of the printer 1 are described. A paper cassette 402 loading recording papers P is inserted to the printer main body 401. By rotation of a paper-feeding roller 403, the recording paper P is separated and fed one by one from the paper cassette 402 to the internal portion of the printer 1. In this stage, the recording paper P is pressed against the paper-feeding roller 403 by a push-up board 420 which is pressed by a spring 419. The recording paper P, conveyed by rotation of the paper-feeding roller 403, is gripped and conveyed by a pair of conveyance rollers comprising a pinch roller 442 and a grip roller 441, and is thereby reciprocally movable with high precision in the printing unit.

In the printing unit, a platen roller 405 is arranged opposite to a thermal head 406, which generates heat in accordance with printing data, with the recording paper conveyance path in between. An ink sheet cassette 407 contains an ink sheet 408 having an ink layer where heat-dissolving or heat-sublimation ink is coated and an overcoat layer which is overcoated on a printing surface for protecting the printing surface. The ink sheet 408 is pressed to the recording paper P by the thermal head 406 and printing elements of the thermal head 406 are selectively heated to transfer the ink of the ink sheet 408 on the recording paper P, thereby forming an image. On the formed image, a protection layer is over-coated.

The ink sheet 408, comprising yellow (Y), magenta (M) and cyan (C) ink layers and an overcoat (OP) layer, each covers the image printing area of the recording paper P and has approximately the same size as the size of the image printing area. Every time each layer of the ink sheet 408 is heat-transferred onto the recording paper P, the recording paper P is returned to the transfer starting position P1. By sequentially transferring the color of each layer on top of each other onto the recording paper P, a full-color image is printed. The recording paper P is reciprocally conveyed by the pair of conveyance rollers 441 and 442 for the number of color inks and overcoat layer.

The recording paper P, on which respective ink layers are transferred (printed paper), is reversed in the front portion of the printer main body 401, transferred through guide units 415 and 425 in the front portion of and below the paper cassette 402, and introduced to the back portion of the printer main body 401.

Since the recording paper P is reversed in the front portion of the printer main body 401, it is possible to eliminate wasted space that would have been generated if the recording paper P is transferred outside the printer main body 401 in the middle of printing, and to prevent a user from unintentionally touching the printed paper P before completing the print of the paper. Therefore, it is possible to reduce the space in the printer 1 installation place. Furthermore, by virtue of directly utilizing the bottom portion of the paper cassette 402 as the paper guide, it is possible to reduce the thickness of the printer main body 401. Moreover, since the printed paper P is transferred in the space between the ink cassette 407 and the paper cassette 402, it is possible to minimize the overall height of the printer main body 401. Accordingly, downsizing of the printer 1 can be realized. The processor 418 is a circuit which executes image processing, printing control, communication control with the camera, which will be described later.

The paper conveyance guide 425 of the paper cassette 402 reverses the recording paper P, which has been reversed from the front portion of the printer main body 401, toward the back of the printer main body 401. Having such paper cassette 402 largely contributes to downsizing of the overall printer main body 401.

A paper discharge tray 426, which is the top surface of the paper cassette 402, serves as a tray of the recording paper P which has been printed and discharged. Such construction also contributes to downsizing of the printer main body 401.

After completion of transferring respective ink layers, the recording paper P is introduced to paper-discharge rollers 491 and discharge rollers 492, and discharged from the back to the front portion of the printer main body 401. Then, the transfer-printing operation on the recording paper P ends.

The discharge rollers 491 grip the recording paper P only at the time of discharging operation so that the recording paper P is not stressed during printing operation.

The printer main body 401 also has the guide unit 415 for guiding the recording paper P.

A conveyance path 416 for switching a direction of transferring paper introduces the recording paper P to the paper discharging path after the recording paper P is fed.

The thermal head 406 used for printing is integrally attached to the head arm 422, and is evacuated to a position that does not intervene in removal and insertion of the ink cassette 407 when the ink cassette 407 is exchanged. The evacuation is realized by pulling the paper cassette 402 at the time of exchanging the ink cassette 407. The ink cassette 407 is configured to move up or move down as the head arm 422 is pressed or released by the cam unit of the paper cassette 402 in accordance with the removal or insertion of the paper cassette 402.

In the thermal-transfer printing apparatus, printing is performed three times in order of color planes for three colors Y, M and C. Therefore, the control for accurately matching the printing start position with respect to each color is required. For this reason, in the printer 1 performing transfer-printing, the recording paper P is tightly gripped by the above-described pair of conveyance rollers 441 and 442 while the paper is conveyed. Further, a margin where printing cannot be performed is necessary at the end portion of the recording paper P in the paper-transferring direction.

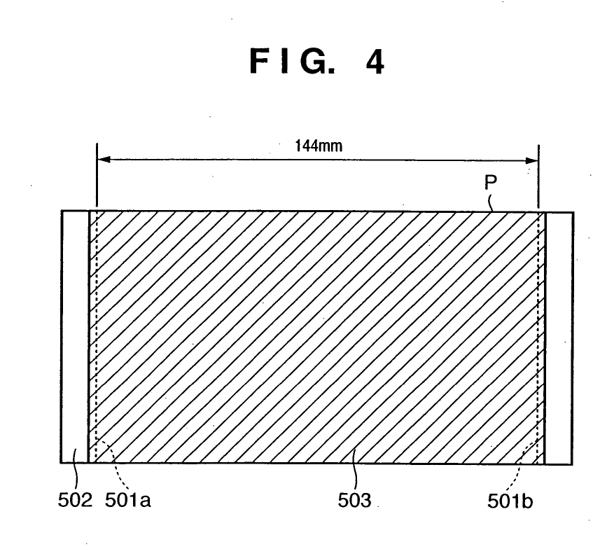

In order to ultimately obtain a frameless printout, for instance, as shown in FIG. 4, the recording paper P has a margin, on which an image is not transferred (printed), for being gripped tightly by the pair of conveyance rollers 441 and 442 when the image-transfer is started. At the boundary of the margins, perforations 501a and 501b which can easily be torn by hands after image transferring operation are provided. This embodiment will be described under a condition in which the recording paper P having perforations 501a and 501b as well as the printer 1 are employed.

The recording paper P shown in FIG. 4 is overcoated for protecting the printed surface. Assume that the areas of the perforations 501a and 501b are also overcoated. Printing is controlled so that the overcoated portion, which is approximately an area where an image is transferred, is slightly larger than the image-transfer area and includes the entire image-transfer area. The printing area 503 (hatched portion) is the printing area where an image is printed. In the printing area 503, printing is controlled so that an image is transferred to an area outside the perforations 501a and 501b.

Printing operation on the above-described recording paper P is described further in detail. In the printer 1 shown in FIG. 3, the pair of conveyance rollers consists of pinch rollers 442 and grip rollers 441. The grip rollers 441 are directly connected to the output axis of a stepping motor (not shown) through a deceleration mechanism, and driven in the forward and reverse directions by rotation of the stepping motor. Since the recording paper P is tightly gripped and reciprocally conveyed by the pair of conveyance rollers 441 and 442, the recording paper P is also accurately position-controlled and conveyed by rotation of the stepping motor.

As an example, assume that the printing pitch of the thermal head 406 for one line is 85 μm, and the number of steps of the stepping motor for conveying the recording paper P by one line is 4 steps. In this case, the recording paper P is conveyed for one line, i.e., 85 μm, by 4 steps of rotation of the stepping motor.

Assuming that the length of the printing area 503 of the recording paper P shown in FIG. 4 is 144 mm in the conveyance direction, 1694 lines can be printed in the printing area 503. To convey the recording paper P for this length, the stepping motor is driven for 6776 steps.

Looking at the pair of conveyance rollers 441 and 442 from the paper-feeding roller 403 in the printer 1 shown in FIG. 3, an edge detection sensor 410 is provided at a position before the pair of conveyance rollers 441 and 442. When the edge detection sensor 410 detects the leading edge of the recording paper P, the recording paper P is conveyed for a distance corresponding to a predetermined line within a range that the pair of conveyance rollers 441 and 442 can grip, and then stopped. The position where the recording paper P stops is the aforementioned transfer starting (print start) position.

At the transfer starting position, each printing element of the thermal head 406 is heated sequentially beginning from the initial color yellow (Y) in accordance with printing data, and images of respective color inks are transfer-printed. Each time the transfer-printing is completed for one color of ink, the recording paper P is conveyed in the direction of discharge roller 491 for a distance corresponding to the number of lines printed in one page, and returned to the aforementioned transfer starting position. The above-described operation is repeated each time printing is performed for respective colors Y, M, and C and the overcoat layer is transferred. In other words, the operation is repeated four times.

The distance between the recording paper's edge detection sensor 410 and the paper pressuring position pressured by the platen roller 405 and the thermal head 406 is set in 20 mm on the recording paper P, taking the arrangement of components in the printer main body 401 into consideration. However, the distance is not limited to this.

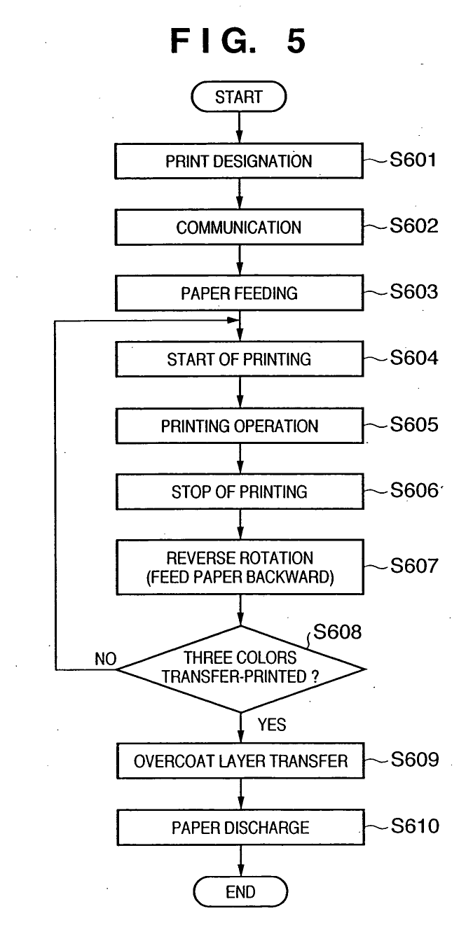

FIG. 5 is a flowchart describing an operation for transferring respective colors of ink and an overcoat layer on the recording paper P shown in FIG. 4 in the printer 1 according to the present embodiment.

In step S601, a user designates printing operation by, e.g., a print designation button of a terminal, print designation from a digital camera or a digital video camera, or the like. In step S602, the processor 418 in the printer main body 401 of the printer 1 starts communication with the camera DC or the system which has received the user's print designation, and performs data reception and confirmation of various conditions necessary for printing. If necessary, the processor 418 executes image processing on the image data (printing data) obtained by the data reception. Furthermore, the processor 418 controls the entire printer for taking charge of controls related to various roller driving and head movement.

When printing preparation is ready, next in step S603, the processor 418 drives the motor connected to the paper-feeding roller 403 to start feeding the recording paper P. Next, in step S604, when the recording paper's edge detection sensor 410 detects the leading edge of the recording paper P conveyed, the stepping motor is driven for a predetermined number of steps to move the recording paper P to the transfer starting position. Then, image transfer is started on the recording paper P. Herein, the transfer starting position of the recording paper P is set, e.g., 12.475 mm from the leading edge of the recording paper P as a reference. Next, in step S605, the stepping motor is driven for 4 steps while the thermal head 406 is heated, and transfer-printing is performed for one line on the recording paper P. The transfer-printing for one line is repeatedly executed for one page, and an image for 6776 steps (1694 lines.) is transfer-printed on the recording paper P. By this, transfer-printing of one color on the recording paper P is completed. In this stage, the transfer ending position is, e.g., 156.455 mm from the leading edge of the recording paper P as a reference. Next, in step S606, the stepping motor is driven for about 10 lines (40 steps) for deceleration and then stopped. In step S607, the stepping motor is reverse-driven to convey the recording paper P in the opposite direction to the printing conveyance direction and is returned for a predetermined number of steps (deceleration of 6776 steps). For further deceleration, the stepping motor is driven for about 10 lines (40 steps) and then stopped. The recording paper P is again set at the transfer starting position.

In step S608, operation in steps S604 to S607 is repeated three times for three colors Y, M and C, thereby transfer-printing the intended color image on the recording paper P. Upon completion of printing the three colors of image, the control proceeds to step S609 where an overcoat layer for protecting the printing surface is transferred once on the recording paper P. In step S610, the printed paper P is transmitted through the guides 415 and 425 toward the back portion of the main body 401, and discharged by rotation of the discharge rollers 492. A series of printing operation on the recording paper P ends.

Note in the above-described transfer-printing operation, the processor 418 controls the number of steps for driving the stepping motor based on the position of the recording paper P and the number of steps of the stepping motor at the time of conveyance, obtained from the edge detection signal of the recording paper P detected by the edge detection sensor 410 at the time of paper P feeding. However, the present invention is not limited to this. For instance, the leading edge of the recording paper P may be detected by a sensor provided at a position at which the recording paper P is positioned at the start time of transfer-printing the respective ink colors Y, M and C as well as an overcoat layer, and based on the detection signal by the sensor as a reference, the number of steps for driving the stepping motor may be controlled to manage the printing position on the recording paper P.

Furthermore, transferring the overcoat layer may be performed by turning ON/OFF the heat-driving of the thermal head 406. Alternatively, it may be controlled to gradually increase the heating amount of the thermal head 406 at the start of overcoat layer transfer, and to gradually decrease the heating amount of the thermal head 406 at the end of overcoat layer transfer.

Next, processing performed by the printing system according to the present embodiment is described. Assume that image data subjected to printing is stored in advance as image data complying with the JPEG method (JPEG image) in the storage medium 206 of the digital camera DC.

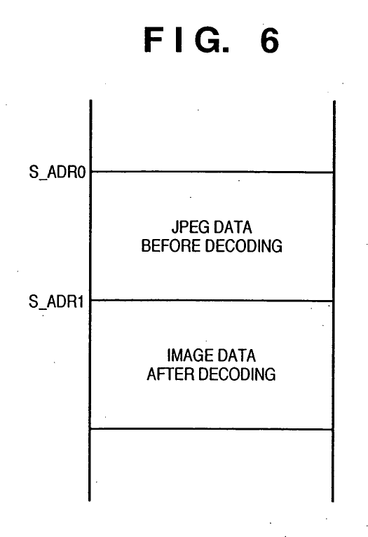

The CPU 202 reads the JPEG image, which is subjected to printing, from the storage medium 206, and develops the image data in the work memory of the memory 203. The memory map of the work memory in this stage is shown in FIG. 6. The read image data herein corresponds to the “JPEG data before decoding” and is stored from an address of “S_ADR0” of the memory 203 in FIG. 6.

The CPU 202 supplies the JPEG CODEC 204 with the JPEG data, e.g., the head address S_ADR0 of the data subjected to decoding, the size of the data, the head address S_ADR1 of the storage location of the decoded data, and so on, and designates to start decoding. The JPEG CODEC 204 performs JPEG decoding and stores the decoded image data into the memory 203 from the head address S_ADR1, and informs the CPU 202 of completion of the decoding, after the completion of the decoding.

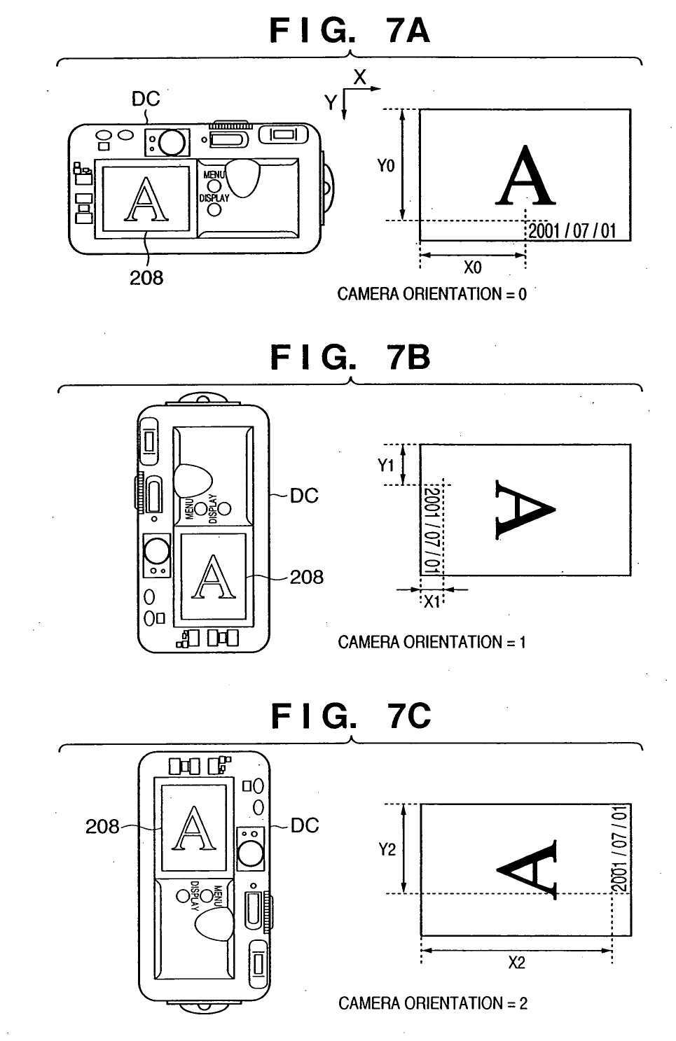

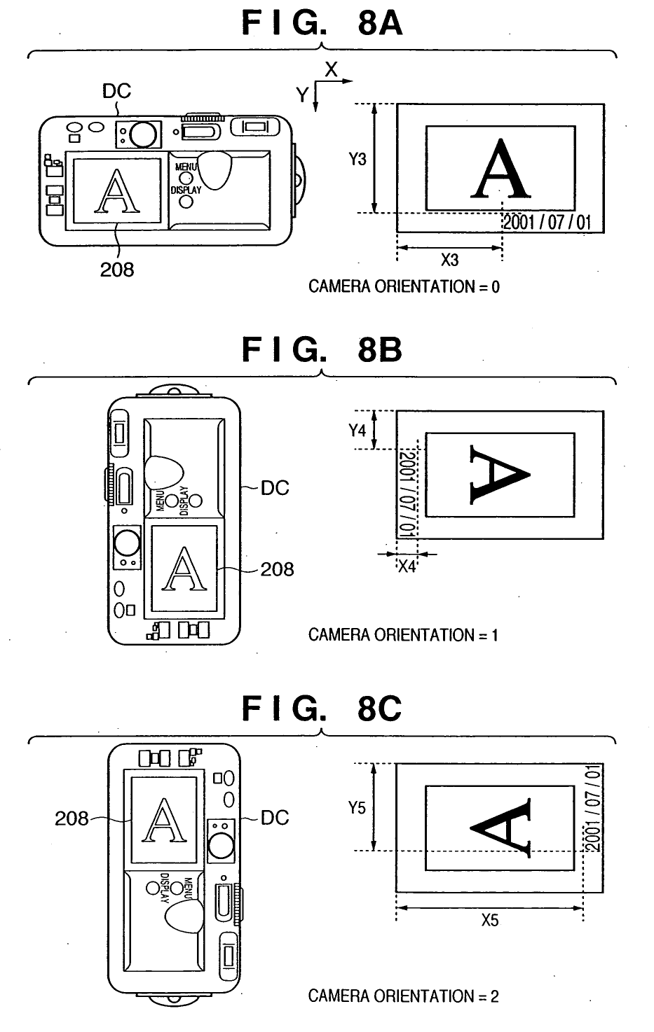

Next, the CPU 202 detects the current orientation of the camera using the camera orientation sensor 207, and stores the orientation data in the work memory 203. For instance, as shown in FIGS. 7A to 7C and FIGS. 8A to 8C, in a case where a landscape image (sideways) is sensed, orientation data “0” is stored; in a case where the camera is rotated counterclockwise by 90° (clockwise by 270° rotation), “1” is stored; and in a case where the camera is rotated clockwise by 90°, “2” is stored as the orientation data in the work memory 203.

Hereinafter, processing is performed in accordance with the camera orientation data stored in the work memory. FIGS. 7A to 7C and FIGS. 8A to 8C are explanatory views showing a relation between the orientation of the digital camera DC and recording paper on which image data and character data (date) are printed. When image printing is designated, a user only has to change the orientation of the digital camera DC in a way that the image displayed on the display unit 208, e.g., an LCD or the like, looks natural. In accordance with the orientation of the image, layout (position, orientation, and direction of character array) of the character data is changed and the characters are printed in the layout.

Note that FIGS. 7A to 7C show a case where there is no margin around the image (frameless); and FIG. 8A to 8C show a case where there is a margin around the image (framed). Assume that the user can select either printing mode “margined” or “no margin” using the user interface of the digital camera DC.

In this embodiment, the origin of the coordinate is the top left of the recording paper, X axis is the right direction and Y axis is the lower direction of the recording paper.

<“No margin” Printing Mode>

In a case of the camera orientation=0 (sideways), the orientation of the image matches with the orientation of the recording paper as shown in FIG. 7A. Therefore, the character string representing the date is printed on the bottom right in the X axis direction with (X0, Y0) as a reference. Since the orientation of each character is vertical, a font having a vertical orientation is selected from the date font data storage unit 201 and printed.

In a case of the camera orientation=1 (270° rotation), the left side of the recording paper corresponds to the bottom of the image as shown in FIG. 7B. Therefore, the date character string is printed in the Y axis direction with (X1, Y1) as a reference. Since the orientation of each character in this case is an orientation corresponding to the 90°-rotated character string shown in FIG. 7A, a font having a 90°-rotated orientation is selected from the date font data storage unit 201 and printed.

In a case of the camera orientation=2 (lengthways with the left end on the top), the right side of the recording paper corresponds to the bottom of the image as shown in FIG. 7C. Therefore, the date character string is printed in the -Y axis direction with (X2, Y2) as a reference. Since the orientation of each character in this case is an orientation corresponding to the 270°-rotated character string shown in FIG. 7A, a font having a 270°-rotated orientation is selected from the date font data storage unit 201 and printed. Note in FIGS. 7A to 7C, the date font data storage unit 201 may store only one type of character font data, and the character font data may be rotated in accordance with the rotation angle of the character string that corresponds to the camera orientation. This also applies to FIGS. 8A to 8C described below.

<“Margined” Printing Mode>

In a case of a printing mode where there is a margin around an image, a date character can be printed on the margin.

In a case of the camera orientation=0, the orientation of the image matches with the orientation of the recording paper, in other words, the lower side of the recording paper corresponds to the bottom of the image as shown in FIG. 8A. Therefore, the date character string is printed in the X axis direction with (X3, Y3) as a reference. Since the orientation of each character is vertical, a font having a vertical orientation is selected from the date font data storage unit 201.

In a case of the camera orientation=1 (270° rotation), the left side of the recording paper corresponds to the bottom of the image as shown in FIG. 8B. Therefore, the date character string is printed in the Y axis direction with (X4, Y4) as a reference. Since the orientation of each character is an orientation corresponding to the 90°-rotated character string shown in FIG. 8A, a font having a 90°-rotated orientation is selected from the date font data storage unit 201.

In a case of the camera orientation=2 (90° rotation), the right side of the recording paper corresponds to the bottom of the image as shown in FIG. 8C. Therefore, the date character string is printed in the -Y axis direction with (X5, Y5) as a reference. Since the orientation of each character is an orientation corresponding to the 270°-rotated character string shown in FIG. 8A, a font having a 270°-rotated orientation is selected from the date font data storage unit 201 and printed.

As described above, when a user designates printing while rotating the camera by 90° or 270° (FIG. 7B, 7C, 8B and 8C) in a way that the image displayed on the display unit 208 is seen lengthways (portrait), the date is laid out at the position and orientation in which the date stamp can be read naturally. In the meantime, when a user designates printing while rotating the camera to the normal sideways orientation (FIGS. 7A and 8A) in a way that the image displayed on the display unit 208 is seen sideways (landscape), the date is laid out at the bottom right position and orientation in which the date stamp can be read naturally. As a result, it is possible to print an image with a natural easy-to-see date stamp.

For instance, assuming a case of sensing characters image of paper placed in lengthways orientation which has vertical writing, the characters image falls in nicely if the camera is oriented as shown in FIG. 7A and the paper is rotated 900. In this case, if printing is designated in the orientation of the camera as shown in FIG. 7A, character data representing a date is printed in the orientation shown in FIG. 7A. However, the orientation of the date does not match the orientation of the characters on the paper, because the characters are written in the vertical direction (the bottom of the characters image is left side). In such case, the camera is rotated as shown in FIG. 7B in a way that the characters image displayed on the display unit 208 is seen lengthways like the orientation of the writing on the paper, then printing is designated. By this, the date character string is printed at an appropriate position as shown in FIG. 7B and in the orientation of the characters image that matches the orientation of the writing on the sensed characters image. This is the same as in the frameless printing as shown in FIGS. 8A-8C.

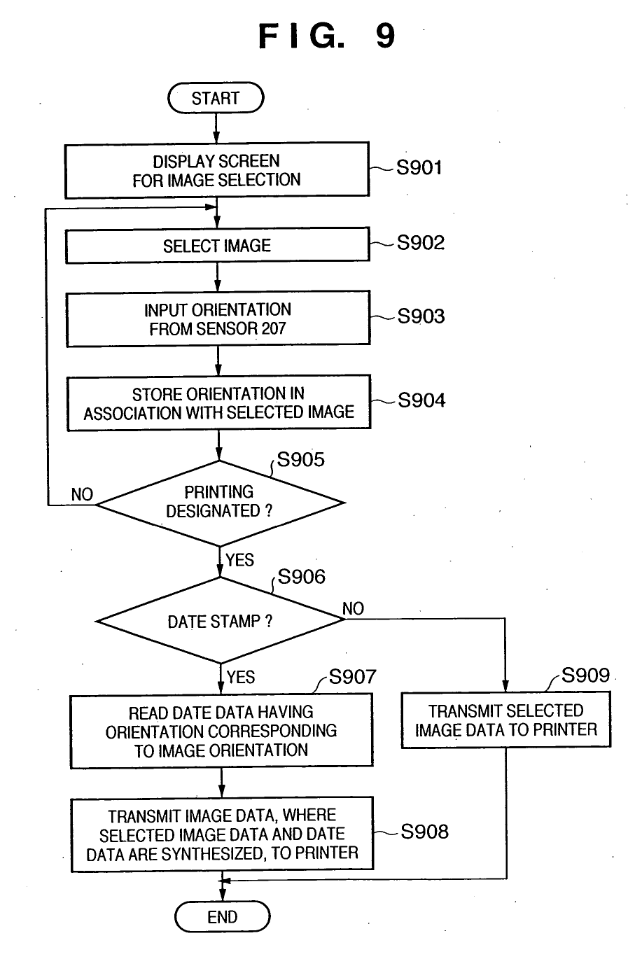

FIG. 9 is a flowchart describing selection processing of a printing target image and output processing of an image to a printer, performed by the digital camera DC according to the present embodiment. The program which executes this processing is stored in the program area of the memory 203.

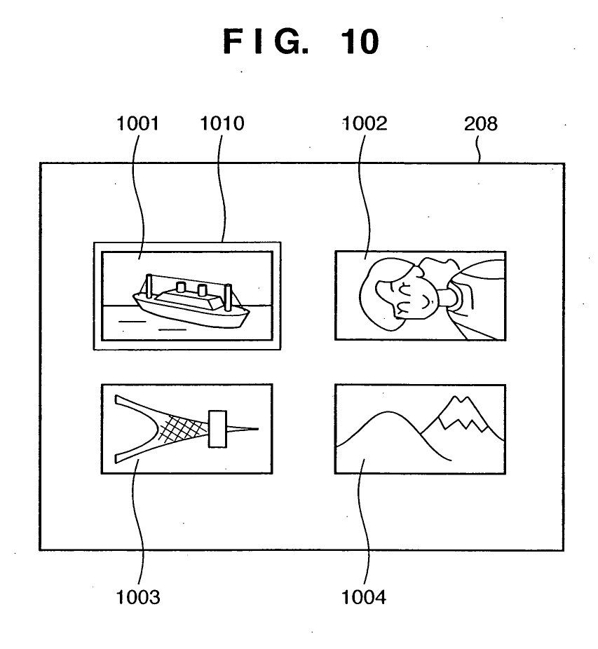

The processing starts when the operation unit 209 of the camera DC is operated and printing is designated. In step S901, a screen for selecting a target image to be printed is displayed on the display unit 208. Plural indexed images where respective images are reduced (FIG. 10) may be displayed, or each image may be sequentially displayed. When a user selects a target image by operating the operation unit 209 in step S902, the control proceeds to step S903 where the orientation of the camera DC at that moment is acquired by the signal from the sensor 207. In step S904, the selected image is stored in association with the orientation of the camera DC at that moment in the work area of the memory 203. In step S905, it is determined whether or not printing start has been designated. When printing start is designated, the control proceeds to step S906; otherwise, the control returns to step S902 for selecting the next target image. Plural printing target images can be selected in this manner.

In step S906, it is determined whether or not a date stamp is designated. If a date stamp is not designated, the control proceeds to step S909 where the image data of the selected image is transmitted to the printer 1 for printing. If a date stamp is designated in step S906, the control proceeds to step S907. The date font corresponding to the orientation of the camera, which is stored in association with the selected image, is read out of the date font data storage unit 201. In step S908, image data is generated by synthesizing the date font with the image data of the selected image, and the generated image data is transmitted to the printer 1 for printing. Note in steps S908 and S909, the image data to be transmitted to the printer 1 may be JPEG-coded by the JPEG CODEC 204, and the coded data may be transmitted to the printer 1. Further, in a case where plural images are selected, processing in steps S907 and S908 is performed for the number of times corresponding to the number of selected target images.

In a case where each target image is designated and the printing of each target image is independently designated, the camera orientation at the time of designation of printing may determine the layout of the date stamp as described above. However, in a case where plural index images are displayed and a plurality of target images are selected from the displayed plural images and after then printing of the target images is designated, the camera orientation at the time of each selection determines the layout of the date stamp of the image.

FIG. 10 depicts an explanatory view of step S902 in FIG. 9, where a target image is selected from the plural indexed images displayed on the display unit 208 of the camera DC.

In FIG. 10, numerals 1001 to 1004 denote respective indexed images; and numeral 1010 denotes a cursor. A desired image can be selected by moving the cursor 1010 (in FIG. 10, the image 1001 is selected) and depressing a selection key (not shown) of the operation unit 209. The camera orientation at the time of this selection determines the layout of the date stamp (orientation and position).

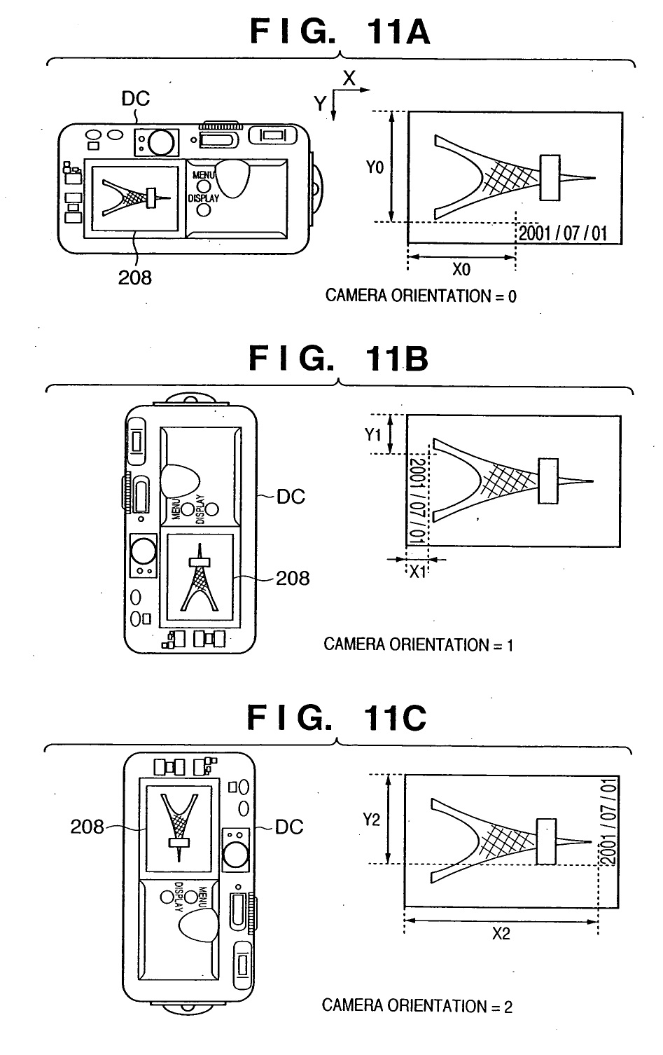

FIGS. 11A to 11C depict explanatory views showing the position of a date stamp and the camera orientation at the time of selecting the target image 1003 in FIG. 10.

FIG. 11A shows a case where the image 1003 is selected when the camera orientation is the normal sideways orientation as shown in FIG. 11A. FIG. 11B shows a case where the image 1003 is selected when the camera DC is rotated counterclockwise by 90° (270°) as shown in FIG. 11B so that the image 1003 is orientated in the appropriate orientation for the viewer. In this case, the date character string is printed in the position and orientation that match the orientation of the image 1003 as shown in FIG. 11B. FIG. 11C shows a case where the image 1003 is selected when the camera DC is rotated clockwise by 90° so that the image 1003 is seen upside down. In this case, the date is printed in the orientation opposite to the orientation of the image 1003.

Note that although the above embodiment describes a case where the character data is a date, character data may be of other data, e.g., a file name.

Although the above embodiment describes a case where plural images are stored and one or plural target images are selected to be printed from the stored images, if there is only one image in the storage, the layout of a date stamp may be determined in accordance with the orientation of the camera DC at the time of printing designation of the image.

Furthermore, although the above embodiment describes a case where the digital camera DC generates the image data including date information and transmits it to the printer, the present invention is not limited to this. The digital camera DC may transmit to the printer, the image file, date information of the image, and data indicative of the camera orientation at the time of image designation. In this case, the printer develops the received image file to generate image data, and if a date stamp is designated, generates printing data having character data indicative of the date at a predetermined position of the image data in accordance with the camera orientation data attached to the image data. The printer performs printing based on the printing data developed by the printer, thereby printing an image on which a date stamp is printed at a position shown in FIGS. 7A to 7C or FIGS. 8A to 8C in accordance with the camera orientation.

[Other Embodiment]

In the other embodiment, for example, in a case where the camera orientation=0 (as shown in FIG. 7A or 8A) when a user designates printing operation of an image, the date stamp may not be printed. On the other hand, in a case where the camera orientation=1 or 2 (as shown in FIG. 7B or 7C, 8B or 8C) when a user designates printing operation of the image, the date stamp may be printed at a predetermined position of the image. Namely, in a case where the camera orientation is a predetermined one when a user designates printing operation of an image, the date stamp is not be printed and otherwise the date stamp is printed at a predetermined potion of the image.

The present invention also includes a case where program codes of a software realizing the functions of the above embodiment are provided to a computer of an apparatus or a system connected to various devices so as to cause said various devices to perform operation for realizing the functions of the above embodiment, and said various devices are operated in accordance with a computer program stored in the computer (CPU or MPU) of the system or apparatus.

Furthermore, in this case, the program codes of the software realize the functions of the above embodiment and the program codes constitute the present invention. For a medium transmitting the program codes, a communication medium (wire circuit such as an optical fiber, wireless circuit and so on) in a computer network system (LAN, WAN such as the Internet, wireless communication network and so on) for propagating program data as a carrier wave for supplying the data can be employed.

Furthermore, means for supplying a computer with the aforementioned program codes, e.g., a storage medium storing the program codes, constitutes the present invention. For a storage medium storing the program codes, for instance, a flexible disk, hard disk, an optical disk, a magneto-optical disk, CD-ROM, a magnetic tape, a non-volatile type memory card, and ROM can be used.

Furthermore, besides aforesaid functions according to the above embodiment are realized by executing the program codes which are supplied by a computer, the present invention also includes a case where the program codes working together with an OS (operating system) or other application software working on the computer realize the functions according to the above embodiment.

Furthermore, the present invention also includes a case where, after the supplied program codes are written in a function expansion card inserted into the computer or in a memory provided in a function expansion unit which is connected to the computer, a CPU or the like contained in the function expansion card or unit performs a part or the entire processes in accordance with designations of the program codes and realizes functions of the above embodiment.

The present invention is not limited to the above embodiment and various changes and modifications can be made within the spirit and scope of the present invention. Therefore, to apprise the public of the scope of the present invention, the following claims are made.

### Claim of Priority

This application claims priority from Japanese Patent Application No. 2003-362501 filed on Oct. 22, 2003, which is hereby incorporated by reference herein.

1. A printing system having an image sensing apparatus and a printer for printing an image based on an image signal from the image sensing apparatus, comprising:
detection means for detecting an orientation of the image sensing apparatus at the time of print designation of image; and
determination means for determining a layout of predetermined character data to be printed with the image in accordance with the orientation of the image sensing apparatus detected by said detection means.

2. The printing system according to claim 1, wherein the character data is date information indicative of a date and time on which the image was sensed by the image sensing apparatus.

3. The printing system according to claim 1, wherein said detection means detects an orientation of the image sensing apparatus at the time of selecting an image subjected to printing.

4. The printing system according to claim 1, wherein the printer is a thermal-transfer printer prints an image on a printing medium, using heating means where a plurality of heating elements are arranged in line and a color ink layer where ink to be transferred to the printing medium by heating of the heating means is coated.

5. The printing system according to claim 1, wherein the printer is an inkjet printer which discharges ink for printing a character or an image on a printing medium with a dot of the ink.

6. An image sensing apparatus having image sensing means for generating an image signal corresponding to a sensed image, comprising:
detection means for detecting an orientation of the image sensing apparatus; and
determination means for determining a layout of character data to be printed with the image in accordance with the orientation of the image sensing apparatus detected by said detection means at the time of print designation of image.

7. The image sensing apparatus according to claim 6, wherein the character data is date information indicative of a date and time on which the image was sensed by the image sensing apparatus.

8. An image sensing apparatus having image sensing means for generating an image signal corresponding to a sensed image, comprising:
detection means for detecting an orientation of the image sensing apparatus;
selection means for selecting an image subjected to printing; and
determination means for determining a layout of character data to be printed with the image in accordance with the orientation of the image sensing apparatus detected by said detection means at the time of selecting the image by said selection means.

9. The image sensing apparatus according to claim 8, further comprising:
storage means for storing image data; and
display means for displaying an image stored in said storage means,
wherein said selection means selects the image subjected to printing from an image displayed by said display means.

10. The image sensing apparatus according to claim 8, wherein the character data is date information indicative of a date and time on which the image was sensed by the image sensing apparatus.

11. The image sensing apparatus according to claim 8, further comprising:
character data storage means for storing a font of the character data;
synthesizing means for reading the font of the character data, whose layout is determined by said determination means, from said character data storage means and synthesizes the read data with image data of the image; and
transmission means for transmitting the image data, synthesized by said synthesizing means, to the printer.

12. A printing method of printing an image based on an image signal from an image sensing apparatus, comprising:
a detection step of detecting an orientation of the image sensing apparatus at the time of print designation in the image sensing apparatus; and
a step of determining a layout of character data to be printed with the image in accordance with the orientation of the image sensing apparatus detected in said detection step.

13. The printing method according to claim 12, wherein the character data is date information indicative of a date and time on which the image was sensed by the image sensing apparatus.

14. The printing method according to claim 12, wherein in said detection step, an orientation of the image sensing apparatus at the time of selecting an image subjected to printing is detected.

15. A control method of an image sensing apparatus having image sensing means for generating an image signal corresponding to a sensed image, comprising:
a detection step of detecting an orientation of the image sensing apparatus; and
a determination step of determining a layout of character data to be printed with the image in accordance with the orientation of the image sensing apparatus detected in said detection step at the time of print designation of image.

16. A control method of an image sensing apparatus having image sensing means for generating an image signal corresponding to a sensed image, comprising:
a detection step of detecting an orientation of the image sensing apparatus;
a selection step of selecting an image subjected to printing; and
a determination step of determining a layout of character data to be printed with the image in accordance with the orientation of the image sensing apparatus detected in said detection step at the time of selecting the image in said selection step.

17. A computer program for controlling an image sensing apparatus, comprising:
means for causing a computer to execute processing for determining a layout of character data to be printed with an image on a printing medium in accordance with an orientation of the image sensing apparatus detected at the time of print designation of the image.

18. A computer-readable storage medium for storing the computer program described in claim 17.

19. An image sensing apparatus having image sensing means for generating an image signal corresponding to a sensed image, comprising:
a detection unit configured to detect an orientation of the image sensing apparatus;
an operation unit configured to select an image subjected to printing; and
a determination unit configured to determine a layout of character data to be printed with the image in accordance with the orientation of the image sensing apparatus detected by said detection unit at the time of selecting the image using said operation unit.

20. An image sensing apparatus having image sensing means for generating an image signal corresponding to a sensed image, comprising:
a detection unit configured to detect an orientation of the image sensing apparatus;
an operation unit configured to designate to print of an image; and
a determination unit configured to determine whether or not to print a date data with the image in accordance with the orientation of the image sensing apparatus detected by said detection unit at the time of designation to print the image using said operation unit.

21. A control method of an image sensing apparatus having image sensing means for generating an image signal corresponding to a sensed image, comprising the steps of:
detecting an orientation of the image sensing apparatus;
designating to print of an image; and
determining whether or not to print a date data with the image in accordance with the orientation of the image sensing apparatus detected in said detecting step at the time of designating to print in said designating step.
